(19) United States
(12) Patent Application Publication
(10) Pub. No.: US 2026/0361517 A1
(43) Pub. Date: Nov. 12, 2026

(54) DATA-CAPSULE-BASED DYNAMIC KEY EXCHANGE METHOD AND MESSAGE ENCRYPTION SYSTEM

(71) Applicant: LITE-ON TECHNOLOGY CORPORATION, TAIPEI CITY (TW)

(72) Inventors: CHUNG-JEN YANG, TAIPEI CITY (TW); Ming-Yi Liao, TAIPEI CITY (TW); Wei-Jia Su, TAIPEI CITY (TW)

(21) Appl. No.: 19/411,375

(22) Filed: Dec. 8, 2025

Related U.S. Application Data
(60) Provisional application No. 63/801,845, filed on May 8, 2025.

(30) Foreign Application Priority Data
Sep. 9, 2025 (CN) 202511279496.5

(51) Int. Cl. H04L 9/08; H04L 9/30; H04L 9/32

(52) U.S. Cl. CPC H04L 9/0825; H04L 9/30; H04L 9/3236

(57) ABSTRACT

A data-capsule-based dynamic key exchange method and a message encryption system. In a transmitter, a data capsule having a key, a verification value used to verify the key and a time-to-live of the key is created. The data capsule is segmented into multiple capsule fragments, and the capsule fragments are respectively inserted into multiple insertion positions of a message payload for creating a new message. The new message is transmitted to a receiver. The receiver receives the new message and the message payload in the new message can be verified by a hash value recorded in a header of the new message. The multiple capsule fragments can be obtained according to the multiple insertion positions recorded in the message payload. The data capsule is then recovered by combining the multiple capsule fragments. The key is extracted when the key is verified by the verification value in the data capsule.

### CROSS-REFERENCE TO RELATED PATENT APPLICATION

This application claims the benefit of priority to China Patent Application No. 202511279496.5, filed on Sep. 9, 2025, in the People’s Republic of China. The entire content of the above identified application is incorporated herein by reference.

This application claims the benefit of priority to the U.S. Provisional Patent Application Ser. No. 63/801845, filed on May 8, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a key encryption technology, and more particularly to a data-capsule-based dynamic key exchange method that establishes a second layer key protection measure over a public network and a message encryption system performing the method.

### BACKGROUND OF THE DISCLOSURE

Virtual private network (VPN) is a technology used to establish a secure connection over a public network, e.g., the Internet. The VPN technology utilizes an encryption technology to establish a point-to-point VPN channel that allows users to transmit data in an encryption manner. The VPN channel likely allows the data to be transmitted over a private network that is isolated from the public network. A primary objective of the VPN is to provide a transmission channel that is characterized by confidentiality, integrity and authentication.

Among encryption technologies for the virtual private network, Diffie-Hellman Key Exchange (DHKE) is one of the key exchange algorithms that allow two parties to negotiate a secret key to be shared over an insecure channel. Further, Elliptic-curve Diffie–Hellman (ECDH) is one of variants of DHKE key exchange technology. The ECDH is a key agreement protocol that provides higher security connection with a shorter key. Rivest-Shamir-Adleman (RSA) is another asymmetric encryption algorithm. RSA is not only used to encrypt data, but also to exchange keys, where one party uses a public key provided by the other party to encrypt a session key and then transmits the encrypted session key to the party.

However, a conventional key-exchange method, e.g., the above-mentioned DHKE, transmits a key directly between the two parties, or transmits the key that is encrypted by a public key. Even though the conventional technologies provide high security channels to transmit the key, there still exists a risk where the key may be intercepted during transmission.

### SUMMARY OF THE DISCLOSURE

In response to the above-referenced technical inadequacies with conventional encryption technologies for key exchange where the key to be transmitted may still be intercepted, provided in the present disclosure is a data-capsule-based dynamic key exchange method and a message encryption system. One of the technical measures of the method is to implement an embedded key-exchange technology by adding a second-layer key protection mechanism to a virtual private network (VPN) channel.

In one aspect of the data-capsule-based dynamic key exchange method, the method is performed in a transmitter, a data capsule is firstly established, the data capsule includes a key and a verification value used to verify the key, and also records a time-to-live of the key. The data capsule is segmented into multiple capsule fragments and the multiple capsule fragments are respectively inserted into multiple insertion positions of the message payload so as to form a new message. The new message is then transmitted to the receiver. The transmitter then receives an acknowledge message (ACK) from the receiver when the key has been verified and the process of key exchange is accomplished.

Further, in the transmitter, when the key is determined to be expired according to the time-to-live, a new key is generated and the multiple capsule fragments that are segmented from the data capsule having the new key are re-calculated.

Further, a quantity of the multiple capsule fragments is determined according to a length of the message payload and another length of the data capsule. A process of determining the quantity of the capsule fragments includes dividing a total length of the message payload and the data capsule by an integer to obtain a first quotient and a first remainder. If a sum of the first quotient and the first remainder is less than or equal to the integer, the sum of the first quotient and the first remainder is set as the quantity of the multiple capsule fragments. Otherwise, if the sum of the first quotient and the first remainder is larger than the integer, the sum of the first quotient and the first remainder is divided by the integer to obtain a second quotient and a second remainder. After that, the second quotient is set as the first quotient and the second remainder is set as the first remainder, by which the step of determining the quantity of the multiple capsule fragments is repeated.

Further, multiple insertion positions of the message payload to be inserted with the multiple capsule fragments can be determined according to multiple offsets that have the same or different values.

Further, the multiple offsets that have the same or different values are obtained by a random calculation based on the message payload.

Still further, multiple characters are selected from the message payload and multiple American Standard Codes for Information Interchange corresponding to the multiple characters are used to determine the multiple offsets.

Further, in the data-capsule-based dynamic key exchange method, a verification value used to verify a key is a hash value that is calculated by a hash operation performed on the key.

The capsule fragments are respectively inserted into the multiple insertion positions of the message payload so as to generate a new message and a header of the new message. The new message header is configured to record the hash value that is calculated by the hash operation performed on the new message.

Further, both the new message and a header of the new message are transmitted to the receiver. In the receiver, the hash value is used to verify the new message and the multiple capsule fragments are obtained according to the multiple insertion positions in the new message. The multiple fragments are combined to recover the new data capsule, and the key can be obtained by using the verification value to verify the key. The key can therefore be retrieved.

In an aspect of the data-capsule-based dynamic key exchange method, after the receiver receives the new message from the transmitter, the new message can be verified according to a hash value recorded in a header of the new message and multiple capsule fragments can also be obtained according the multiple insertion positions of the message payload. The data capsule can be recovered by combining the multiple fragments. The key can be verified by a verification value carried by the data capsule. The key is therefore obtained.

In an aspect of the message encryption system, the system includes a transmitter that firstly generates a key and a verification value used to verify the key. The key and the verification value are recorded in the data capsule. The data capsule is segmented into multiple capsule fragments, and the multiple capsule fragments are respectively inserted into multiple insertion positions of a message payload so as to form a new message. The system also includes a receiver. A channel between the receiver and the transmitter is established, by which the receiver receives the new message from the transmitter. The new message can be verified according to a hash value recorded in a header of the new message. Multiple capsule fragments can be obtained from multiple insertion positions of the message payload. The data capsule can be recovered by combining the multiple capsule fragments. The key can also be extracted after using the verification value to verify the key in the data capsule. The purpose of key exchanging is achieved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a framework of a message encryption system according to one embodiment of the present disclosure;

FIG. 2 is a flowchart illustrating an operating process of the message encryption system according to one embodiment of the present disclosure;

FIG. 3 is a flowchart illustrating a data-capsule-based dynamic key exchange method according to one embodiment of the present disclosure;

FIG. 4 is a flowchart illustrating a process of delivering a key by a transmitter of the message encryption system according to one embodiment of the present disclosure;

FIG. 5 is a flowchart illustrating a process of extracting the key by a receiver of the message encryption system according to one embodiment of the present disclosure; and

FIG. 6 is a flowchart illustrating a process of determining a quantity of capsule fragments of a data capsule in the message encryption system according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a data-capsule-based dynamic key exchange method and a message encryption system. The technical concept of the data-capsule-based dynamic key exchange method is to use a data capsule generated through a security calculation to encapsulate a key when the key is configured to be transmitted via a conventional encrypted channel to another side. One of the technical measures is to incorporate a second-layer key-protection approach to a virtual private network (VPN) that initiates a channel to deliver the key. The key and related information is configured to be encapsulated into a capsule being hidden in a normal data to be transmitted via the channel. Further, an approach where multiple capsule fragments are inserted with dynamic offsets is incorporated, so as to determine multiple insertion positions of the capsule for inserting the multiple capsule fragments based on the content of a message payload. This approach increases complexity of key extraction for improving secrecy and anti-analytics of key exchange. In certain embodiments, the key is a private key of a key pair, a public key of the key pair is used to encrypt the private key by an encryption algorithm, and the encrypted private key is stored in the data capsule.

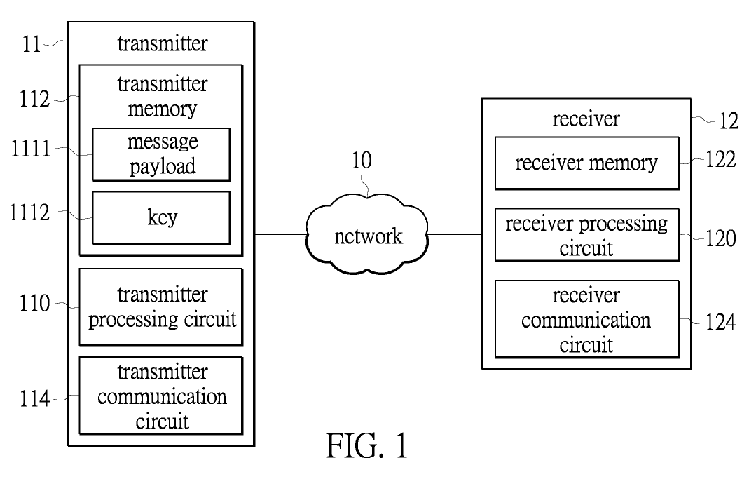

The data-capsule-based dynamic key exchange method can be applied to the message encryption system essentially consisting of a transmitter and a receiver. Reference is made to FIG. 1, which is a schematic diagram depicting a framework of the message encryption system according to certain embodiments of the present disclosure.

The message encryption system shown in FIG. 1 includes a transmitter 11 and a receiver 12. A virtual private network (VPN) can be established between the transmitter 11 and the receiver 12. The transmitter 11 and the receiver 12 may function as a server side such as a VPN server and a client side such as a VPN client device. Further, the server side and the client side can also be two computer devices that are communicated via a network 10. Still further, the server side and the client side may represent a control side and an IoT terminal.

Main circuit components of the transmitter 11 include a transmitter processing circuit 110, and a transmitter memory 112 and a transmitter communication circuit 114 that are electrically connected with the transmitter processing circuit 110. For establishing a security channel between the transmitter 11 and the receiver 12, the transmitter memory 112 is configured to store a key 1112 that is dynamically generated and a message payload 1111 used for implementing the data-capsule-based dynamic key exchange method of the present disclosure. Main components of the receiver 12 include a receiver processing circuit 120, and a receiver memory 122 and a receiver communication circuit 124 that are electrically connected with the receiver processing circuit 120.

The virtual private network (VPN) is established between the transmitter communication circuit 114 of the transmitter 11 and the receiver communication circuit 124 of the receiver 12 over a public network (e.g., Internet) through a specific communication protocol. The data can be transmitted over the virtual private network. Nevertheless, when a VPN channel is initiated, one of the sides (e.g., the transmitter 11) provides a key used for encryption and decryption there-between. A public key that is coordinated by both sides is used to encrypt the key and the encrypted key is transmitted to the other side (e.g., the receiver 12) via the network 10. The key is then extracted by a decryption process.

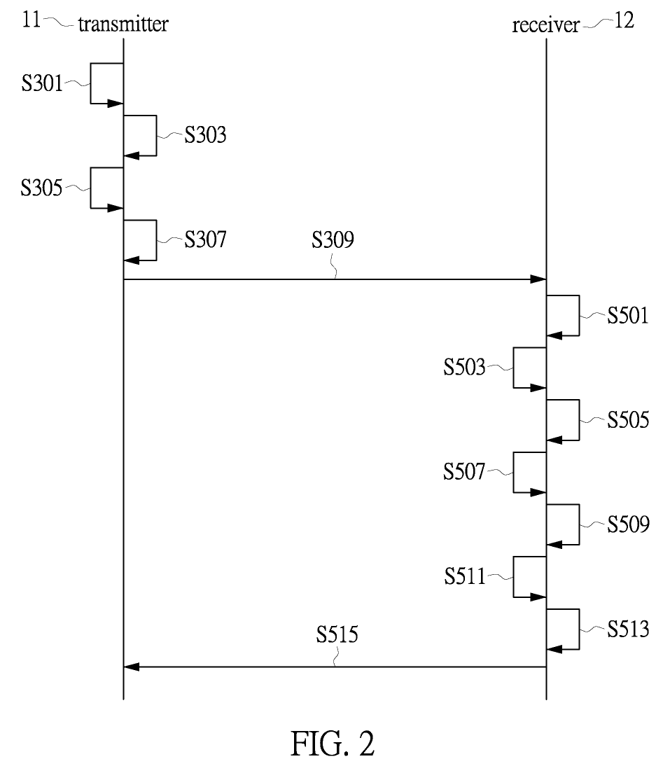

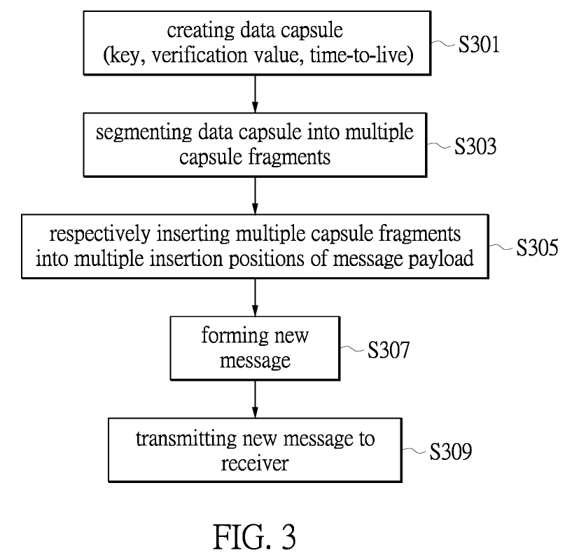

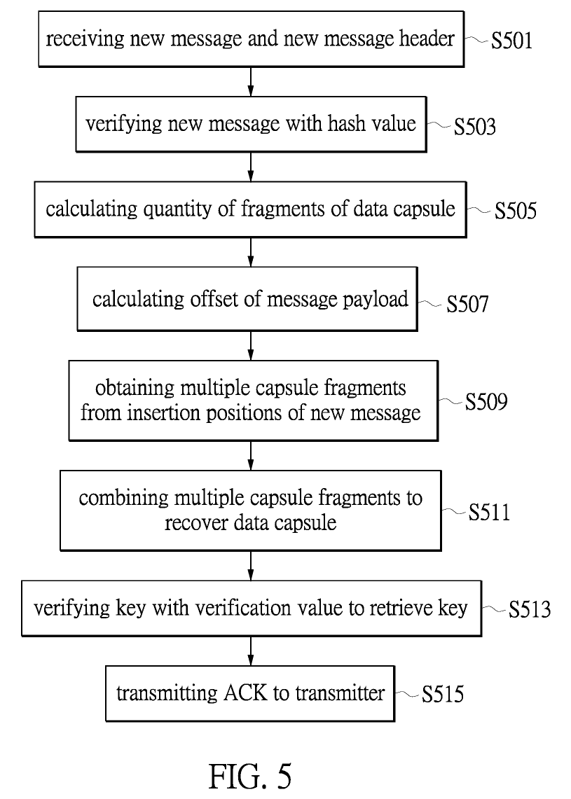

When the key is transmitted to the receiver 12, a data-capsule-based dynamic key exchange channel can be established between the transmitter 11 and the receiver 12. Reference is made to FIG. 2, which is a flowchart illustrating a process of exchanging the key between the transmitter 11 and the receiver 12 in the message encryption system. References are also made to FIG. 3, which is a flowchart illustrating a process performed by the transmitter 11 and FIG. 5, which is another flowchart illustrating a process of extracting the key performed by the receiver 12 according to certain embodiments of the present disclosure.

The flowcharts of FIGS. 2 and FIG. 3 illustrate that a second-layer key protection approach applied to a security channel, in which the transmitter 11 generates a key on demand and sets a validity duration (i.e., a time-to-live (TTL)) thereto. The key can be used as a session key for ensuring a secure transmission between the transmitter 11 and the receiver 12. In the flowcharts, the transmitter 11 defines a data capsule that is configured to store the key and related information. The related information at least includes a verification value used to verify the key and the time-to-live of the key (step S301).

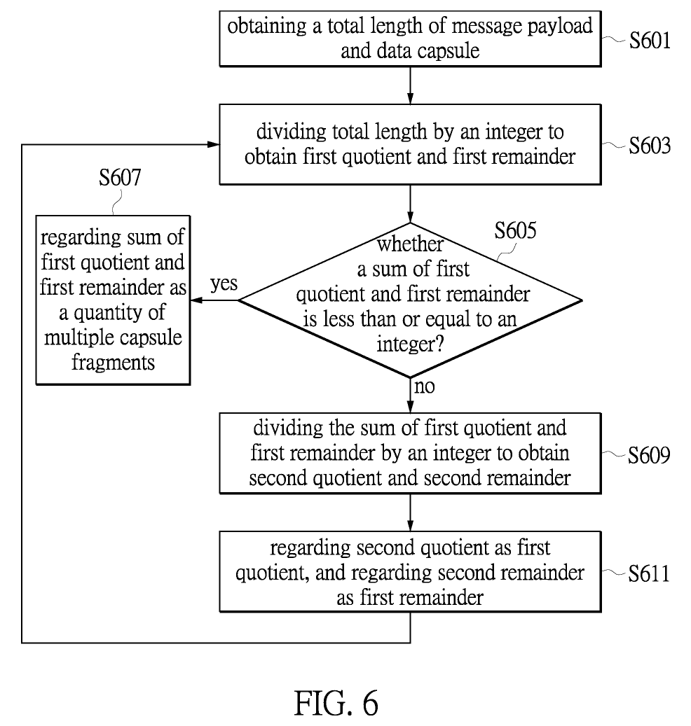

Next, the data capsule is segmented into multiple capsule fragments in response to a determined quantity of the capsule fragments (step S303). The quantity of the capsule fragments is determined based on a length of a message payload of the key to be recorded and another length of the data capsule. Further, reference is made to FIG. 6, which is a flowchart illustrating a process of determining the quantity of the fragments segmented from the data capsule according to the embodiment of the present disclosure. The quantity of the capsule fragments and the insertion positions of these capsule fragments can be determined, by which the multiple capsule fragments are configured to be inserted into multiple insertion positions of the message payload (step S305) so as to form a new message (step S307). After that, the new message can be transmitted to the receiver via a specific channel such as a virtual private network (step S309).

In the above-described technology, integrating the key into the data capsule simplifies key management since the key, the time-to-live of the key and information used to verify integrity are integrated into a data capsule. Further, in the transmitter 11, a monitoring sequence operated in a transmitter processing circuit determines whether or not the key is required to be re-generated according to the time-to-live of the key. If it is determined that the key is about to expire, for example, only three seconds of the time-to-live are left, or has already expired, a new key is generated. Further, the multiple capsule fragments that are segmented from the data capsule having the new key are re-calculated. The concept of the data capsule allows the fragments of the key in the message payload to be hidden, and forces the key to be updated within a time limit. Therefore, the data-capsule-based dynamic key exchange method of the present disclosure can improve security of data transmission. Further, high security transmission for an encrypted data can be achieved by increasing difficulty of cracking the key by frequently changing the key.

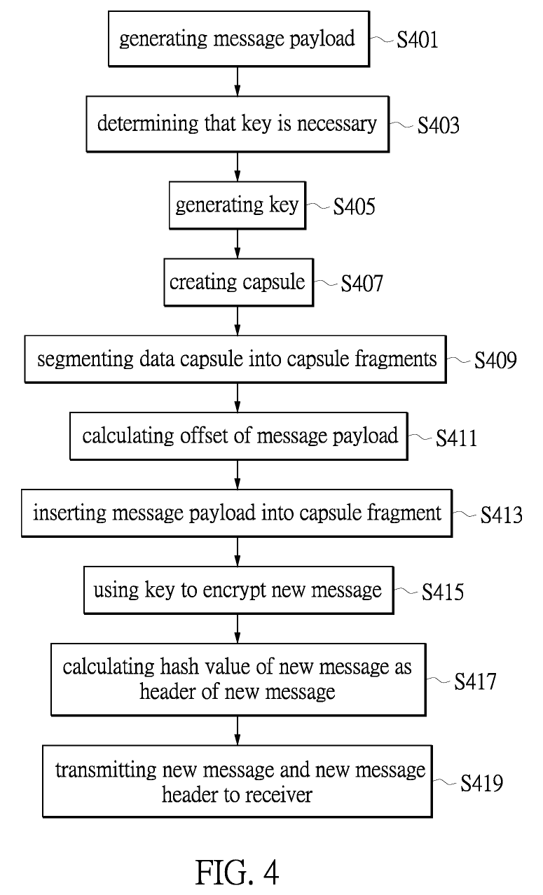

In addition to the above step performed by the transmitter 11, further details are shown in the flowchart described in FIG. 4 in one embodiment of the present disclosure. The flowchart illustrates that the transmitter 11 firstly generates a message payload to be transmitted to the receiver 12 (step S401). The message payload can be a valid data that is actually carried by a message over the network. In the data-capsule-based dynamic key exchange method, one purpose of the message payload is to carry the data capsule having the key.

According to certain embodiments of the present disclosure, the transmitter processing circuit of the transmitter 11 randomly generates the message payload with a specific length. The message payload includes a message payload header (msg_header) that records a sequential number (seq) of the data capsule. The sequential number is used to verify a sequence of the messages to be transmitted. The header of the message payload can also be used to quickly check whether the message payload includes a complete content of the data capsule. Next, it is determined whether or not to generate the key (step S403). If it is determined that the key is necessary, a new key can be generated based on the current information of time-to-live. Therefore, the transmitter processing circuit of the transmitter 11 performs an algorithm to generate the key (step S405) and creates a data capsule used to record the key and the related information (step S407).

In one of the aspects of the data capsule, the data capsule has a length (capsule_len), e.g., 128 bytes. The key and some additional information are stored in the data capsule. The additional information may include, but not limited to, a Hash-based Message Authentication Code (HMAC), a length of the Hash-based Message Authentication Code (HMAC len), a key occupying about 256 to 4096 bits, a key length (key_len) (e.g., 16 bits), a time-to-live (key_ttl) (e.g., 1 to 255 seconds and occupying about 32 bits), a footprint (e.g., represented in SHA256), a footprint length (footprint_len) (e.g., 16 bits), a code of an operating system (OS id) (e.g., Windows id or Linux id), a processor ID (cpu id), a media access control address (MAC address) and reserved bytes (default is 0).

In the flowchart shown in FIG. 4, in the transmitter 11, the data capsule is segmented into multiple capsule fragments (step S409). Multiple offsets for the message payload can be calculated (step S411). The multiple capsule fragments can then be inserted into multiple insertion positions having the offsets of the message payload (step S413) to generate a new message and a new message header to be transmitted to the receiver 12. It is worth noting that the new message header may record a hash value calculated from the new message using a hash operation. The hash value can be the HMAC.

In one of the embodiments, multiple offsets are generated through a calculation with random numbers based on the content of the message payload. For example, multiple characters are selected from the message payload and American Standard Codes for Information Interchange corresponding to these characters are used to determine the multiple offsets. After that, these multiple offsets are used to determine the multiple insertion positions of the message payload to be inserted with the multiple capsule fragments. The multiple offsets are identical or different values.

Next, another key (e.g., a public key agreed upon by the two parties) is used to encrypt the new message (step S415). In the meantime, a hash operation is used to calculate a hash value of the new message, and the hash value is recorded in a new message header (step S417). Thus, both the new message and the new message header are transmitted to the receiver 12 (step S419). Afterwards, when the transmitter 11 receives an acknowledge message (ACK) from the receiver 12, the process of key exchange is accomplished.

When the transmitter 11 transmits the new message and the new message header, the receiver 12 of the message encryption system receives the new message and the new message header and performs subsequent steps as described in FIGS. 2 and FIG. 5, illustrating the process of the receiver 12 extracting the key according to one embodiment of the present disclosure.

As shown in FIGS. 2 and 5, the receiver 12 receives both the new message and the new message header (step S501). In the receiver 12, the hash value that is calculated in the transmitter 11 for the new message can be obtained from the new message header. The hash value is used to verify authenticity of the new message and to confirm integrity of the new message. For example, a HMAC is calculated from the new message retrieved from the data capsule and is compared with the HMAC recorded in the new message header (step S503). In one of the embodiments of the present disclosure, the same hash operation adopted by both the receiver 12 and the transmitter 11 is performed on the new message to calculate a hash value that is compared with the hash value obtained from the new message header to verify the new message.

Next, a quantity of the capsule fragments can be calculated based on the new message (step S505) and offsets of the multiple insertion positions of the message payload to insert the multiple capsule fragments can also be calculated (step S507). Therefore, a software sequence operated in a processing circuit of the receiver 12 can rely on the multiple insertion positions of the new message to recover the multiple capsule fragments (step S509), so that the data capsule can be recovered by combining the multiple capsule fragments (step S511). Thus, the key and related information recorded in the data capsule can be obtained and a verification value can be obtained for verifying the key. The key is accordingly extracted (step S513). At last, the receiver 12 generates an acknowledge message and transmits the acknowledge message to the transmitter (step S515). This process of dynamic key exchange based on the data capsule is accomplished.

According to one of the embodiments of the data-capsule-based dynamic key exchange method, a key-security mechanism is provided for segmenting an encrypted key (e.g., encrypted by a public key) into multiple segments and hiding the multiple segments within a message payload to be transmitted. That means, rather than directly transmitted to the receiver 12, the encrypted key is segmented into the multiple segments and the multiple segments are scattered to different positions of the message payload, by which the key can be hidden in the data capsule so that secrecy of the key can be improved. Therefore, the traditional interception methods cannot obtain a complete key. Further, the time-to-live designated to the key forces the key to be updated to a new key within a specific time limit and a risk that the key may be cracked for can be effectively reduced by increasing a frequency of replacing the key.

It should be noted that the transmitter 11 inserts information relating to key validity duration management to the data capsule when the data capsule having the key is transmitted to the receiver 12. In one of the embodiments of the present disclosure, the time-to-live (key_ttl) of the key can be set to the data capsule. In one embodiment of the present disclosure, before the key is about to expire (e.g., 3 seconds before expiration), the transmitter 11 re-generates a new key. The new key is then processed by the processing processes described in FIGS. 3 or FIG. 4.

When the transmitter 11 receives an acknowledge message transmitted by the receiver 12 indicating that the key has been verified, the process of key exchange is accomplished. Otherwise, if the transmitter 11 does not receive any response (i.e., the acknowledge message) from the receiver 12 within a determined period of time (e.g., equal to the time-to-live), a new key will be generated after timeout. The key exchanging process will be re-performed while the current key is abandoned. When the receiver 12 obtains the key or the new key and determines that the received key is different from the previous key stored in the memory, the key stored in the memory of the receiver 12 will be updated to the received key. The new key is used to encrypt the message to be transmitted to the transmitter 11. For example, the key is used to encrypt a new message payload. The new encrypted message is then transmitted to the transmitter 11. The virtual private network between the receiver and the transmitter can be implemented.

According to above embodiments of the present disclosure, in the step of segmenting the data capsule having the key into multiple capsule fragments, the quantity of the capsule fragments of the data capsule is required to be determined in advance. In one of the embodiments, the receiver 12 and the transmitter 11 can be coordinated to determine the quantity of the capsule fragments according to a length of the message payload and another length of the data capsule. Reference is made to FIG. 6, which is a flowchart illustrating a process for determining the quantity (“n”) of the capsule fragments of the data capsule in the message encryption system according to one embodiment of the present disclosure.

In the process of the present embodiment, a software sequence performed in a transmitter processing circuit of the transmitter 11 randomly generates a message payload with a specific length (“m”), e.g., 4096 bytes (m=4096). In the meantime, a defined data capsule is referred to for obtaining a total length of the length (“m”) of the message payload and a length (“capsule_len”) of the data capsule (“m+capsule_len”) (step S601). The total length is divided by an integer (“div”) that is set by the system (“(m+capsule_len)/div”). The integer can be a positive integer larger than 1 but not larger than 16. A first quotient (Q) and a first remainder (R) can then be calculated (step S603).

Next, it is determined whether or not a sum of the first quotient and the first remainder (“Q+R”) is less than or equal to the integer ((Q+R)≦div) (step S605). If the sum of the first quotient and the first remainder is less than or equal to the integer (represented as “yes”), the sum obtained at this stage can be set as the quantity of the multiple capsule fragments (“n”) (step S607).

Otherwise, if the sum of the first quotient and the first remainder is not less than or equal to the integer (represented as “no”), the sum of the first quotient (Q) and the first remainder (R) is then divided by the integer (div) (“(Q+R)/div”) to obtain a second quotient (Q’) and a second remainder (R’) (step S609). Afterwards, the second quotient (Q’) is set as the first quotient (Q) and the second remainder (R’) is set as the first remainder (R) (step S611). In the meantime, the process goes back to step S603 for proceeding the subsequent steps by the updated first quotient (Q) and the first remainder (R) until a condition that the sum of the first quotient and the first remainder is less than or equal to the integer is met and the quantity (“n”) of the capsule fragments (“n”) is obtained.

Thus, the quantity of the capsule fragments (“n”) and the multiple insertion positions are used to insert the multiple capsule fragments into the multiple insertion positions of the message payload so as to form the new message to be transmitted to the receiver of the message encryption system.

In conclusion, according to the certain embodiments that describe the data-capsule-based dynamic key exchange method and the data-capsule-based dynamic key exchange method of the present disclosure, one of the objectives is to incorporate a second-layer key-protection approach to a security channel between a transmitter and a receiver of a message encryption system by encapsulating a key into a data capsule. The key and the related information can be hidden in a normal data to be transmitted. Accordingly, the capabilities of secrecy and anti-analytics of the key being exchanged between the transmitter and the receiver can be improved. In the data-capsule-based dynamic key exchange method, after the data capsule is segmented into multiple capsule fragments, the multiple capsule fragments are hidden in the data capsule to be transmitted by inserting the multiple fragments into multiple insertion positions having dynamic offsets of the capsule. Therefore, the data capsule has more complex data structure. The new message to be transmitted between the receiver and the transmitter is formed. The key exchange process is accomplished after the receiver decodes and verifies the key and the related information in the data capsule.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A data-capsule-based dynamic key exchange method, performed in a transmitter, comprising:
establishing a data capsule including a key and a verification value used to verify the key, and recording a time-to-live of the key;
segmenting the data capsule into multiple capsule fragments;
respectively inserting the multiple capsule fragments into multiple insertion positions of a message payload so as to form a new message; and
transmitting the new message to a receiver and completing exchange of the key upon receiving an acknowledge message from the receiver verifying the key.

2. The method according to claim 1, wherein, in the transmitter, when the key is determined to be expired according to the time-to-live, a new key is generated and the multiple capsule fragments that are segmented from the data capsule having the new key are calculated.

3. The method according to claim 1, wherein a quantity of the multiple capsule fragments is determined according to a length of the message payload and another length of the data capsule.

4. The method according to claim 3, wherein a process of determining the quantity of the capsule fragments comprises:
(a) dividing a total length of the message payload and the data capsule by an integer to obtain a first quotient and a first remainder;
(b) if a sum of the first quotient and the first remainder is less than or equal to the integer, the sum of the first quotient and the first remainder is set as the quantity of the multiple capsule fragments; otherwise, if the sum of the first quotient and the first remainder is larger than the integer, the sum of the first quotient and the first remainder is divided by the integer to obtain a second quotient and a second remainder; and
(c) setting the second quotient as the first quotient, setting the second remainder as the first remainder, and repeating the process of (b).

5. The method according to claim 1, wherein multiple insertion positions of the message payload are determined to be inserted with the multiple capsule fragments according to multiple offsets, in which the multiple offsets are multiple identical or different values.

6. The method according to claim 5, wherein the multiple offsets that are identical or different values are obtained by a random calculation based on the message payload.

7. The method according to claim 6, wherein multiple characters are selected from the message payload and multiple American Standard Codes for Information Interchange corresponding to the multiple characters are used to determine the multiple offsets.

8. The method according to claim 1, wherein the verification value used to verify the key is a hash value that is calculated by a hash operation performed on the key.

9. The method according to claim 1, wherein the multiple capsule fragments are respectively inserted into the multiple insertion positions of the message payload so as to form the new message and a new message header that records a hash value of the new message.

10. The method according to claim 9, wherein both the new message and the new message header are transmitted to the receiver, and the receiver relies on the hash value to verify the new message and recovers the data capsule by combining the multiple capsule fragments that are retrieved according to the multiple insertion positions of the new message; and wherein the key is extracted after the key is verified by the verification value.

11. The method according to claim 1, wherein the key is a private key of a key pair, a public key of the key pair is used to encrypt the private key by an encryption algorithm, and the encrypted private key is stored in the data capsule.

12. A data-capsule-based dynamic key exchange method, performed in a receiver, comprising:
receiving a message from a transmitter;
verifying the message according to a hash value recorded in a header of the message;
obtaining multiple capsule fragments from multiple insertion positions of a message payload of the message, and recovering a data capsule by combining the multiple capsule fragments; and
extracting a key after verifying the key by a verification value recorded in the data capsule.

13. The method according to claim 12, wherein the key has a time-to-live, and in the transmitter, when the key is determined to be expired according to the time-to-live, a new key is generated and the multiple capsule fragments that are segmented from the data capsule having the new key are calculated; and, when a previously-stored key is different from the key obtained by the receiver, the key is updated.

14. The method according to claim 12, wherein the receiver and the transmitter are coordinated to determine a quantity of the multiple capsule fragments according to a length of the message payload and another length of the data capsule.

15. The method according to claim 12, wherein the receiver and the transmitter are coordinated to determine multiple offsets, and the multiple insertion positions of the message payload are determined to be inserted with the multiple capsule fragments according to the multiple offsets, in which the multiple offsets are multiple identical or different values.

16. The method according to claim 12, wherein the verification value used to verify the key and the verification value is a hash value that is calculated by a hash operation performed on the key.

17. The method according to claim 12, wherein the key is a private key of a key pair, a public key of the key pair is used to encrypt the private key by an encryption algorithm, and the encrypted private key is stored in the data capsule.

18. A message encryption system, comprising:
a transmitter, generating a key and a verification value used to verify the key, wherein the key and the verification value are recorded in a data capsule, which also records a time-to-live of the key; wherein, after the data capsule is segmented into multiple capsule fragments, the multiple capsule fragments are respectively inserted into multiple insertion positions of a message payload so as to form a new message; and
a receiver, establishing a channel between the receiver and the transmitter; wherein the receiver receives the new message from the transmitter, verifies the message according to a hash value recorded in a header of the new message, obtains the multiple capsule fragments from the multiple insertion positions of the message payload, recovering the data capsule by combining the multiple capsule fragments, and extracting the key after the key is verified by the verification value recorded in the data capsule.

19. The message encryption system according to claim 18, wherein a virtual private network is established between the transmitter and the receiver, the transmitter is a server for the virtual private network, and the receiver is a client device of the virtual private network.

20. The message encryption system according to claim 19, wherein a key pair is provided for the virtual private network to encrypt a message to be delivered, the key is a private key of the key pair, a public key of the key pair is used to encrypt the private key by an encryption algorithm, and the encrypted private key is stored in the data capsule.
